(19) United States
(12) Patent Application Publication
(10) Pub. No.: US 2011/0240452 A1
(43) Pub. Date: Oct. 6, 2011

(54) Keyboard

(75) Inventor: Ling-Shi Chao, Taoyuan County (TW)

(73) Assignee: DARFON ELECTRONICS CORP., Taoyuan Shien (TW)

(21) Appl. No.: 13/075,995

(22) Filed: Mar. 30, 2011

(30) Foreign Application Priority Data
Apr. 1, 2010 (TW) 99205810

(51) Int. Cl. H01H 13/76; H01H 13/02

(52) U.S. Cl. 200/5 A; 200/344

(57) ABSTRACT

A keyboard includes keys are provided. Each key includes a base, inner and outer frames and a key cap. The base has a body, a first hook and two second hooks. The first and second hooks are connected to the body. Each second hook has an L-shaped portion with one end connected to the body, and an inverse hook portion extending from the other end of the L-shaped portion to the body to form a space. The inner frame disposed on the body has a first opening. The first hook passes through the first opening to engage with a portion of the inner frame. The outer frame disposed on the body crosses the inner frame and has two second openings. Each second hook passes through the corresponding second opening to receive a portion of the outer frame in the space. The key cap is on the inner and outer frames.

This application claims the benefit of Taiwan application Serial No. 099205810, filed Apr. 1, 2010, the subject matter of which is incorporated herein by reference.

### BACKGROUND OF THE INVENTION

1. Field of the Invention

The invention relates in general to a keyboard, and more particularly to a keyboard having a key with a hook using the same.

2. Description of the Related Art

With the development of the technology, electronic devices have been widely used. Generally speaking, in order to let the user input data or operate the electronic device, an input device, such as a keyboard or a touch panel, is widely used. For the keyboard, the keys of the keyboard always adopt the scissor structure. Consequently, the user can press the key in a laborsaving manner, and the thickness of the keyboard can also be significantly decreased. However, because the steps of assembling the key with the scissor structure are complicated, the manufacturing time and cost of the keyboard are significantly increased. Therefore, it is an important subject in the industry to provide a key, which can be easily assembled to shorten the manufacturing time and decrease the manufacturing cost.

### SUMMARY OF THE INVENTION

The invention is directed to a keyboard, wherein the structure of a key of the keyboard is designed to achieve the easy assembling effect. Consequently, the keyboard according to the present invention can effectively shorten the manufacturing time and decrease the manufacturing cost.

According to a first aspect of the present invention, a keyboard including a plurality of keys is provided. Each key includes a base, an inner frame, an outer frame and a key cap. The base has a body, a first hook and two second hooks. The first hook and the second hooks are connected to and protrude from the body. Each of the second hooks has an L-shaped portion and an inverse hook portion. One end of the L-shaped portion is connected to the body, and the inverse hook portion extends from the other end of the L-shaped portion to the body so as to form a space. The inner frame is obliquely disposed on the body and has a first opening. The first hook passes through the first opening so as to engage with a portion of the inner frame. The outer frame, disposed on the body, crosses the inner frame and has two second openings. Each of the second hooks passes through the corresponding second opening so as to receive a portion of the outer frame in the space of each of the second hooks. The key cap is disposed on the inner frame and the outer frame.

According to a second aspect of the present invention, a keyboard including a plurality of keys is provided. Each key includes a base, an inner frame, an outer frame and a key cap. The base has a body, a first hook and two second hooks. The first hook and the second hooks are connected to and protrude from the body. Each of the second hooks is an L-shaped member having a first rod and a second rod. One end of the first rod is connected to the body. The other end of the first rod is connected to one end of the second rod. A length of the second rod in a direction is greater than a length of the first rod in the direction. The inner frame is obliquely disposed on the body and has a first opening. The first hook passes through the first opening so as to engage with a portion of the inner frame. The outer frame, disposed on the body, crosses the inner frame and has two second openings. A length of each of the second openings in the direction ranges between the length of the second rod in the direction and the length of the first rod in the direction. Each of the second hooks passes through the corresponding second opening so as to engage with a portion of the outer frame. The key cap is disposed on the inner frame and the outer frame.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic illustration showing a keyboard according to a first embodiment of the present invention.

FIG. 2A is a side view showing one of the keys in FIG. 1.

FIG. 2B is a top view showing the key in FIG. 2A without the key cap.

FIG. 3 is a partially schematic illustration showing a key according to a second embodiment of the present invention.

FIG. 4 is a partially schematic illustration showing a key according to a third embodiment of the present invention.

FIG. 5 is a schematic illustration showing a keyboard according to a fourth embodiment of the present invention.

FIG. 6A is a side view showing one of the keys in FIG. 5.

FIG. 6B is a top view showing the key in FIG. 6A without the key cap.

FIG. 7 is a partially schematic illustration showing a key according to a fifth embodiment of the present invention.

FIG. 8 is a partially schematic illustration showing a key according to a sixth embodiment of the present invention.

### DETAILED DESCRIPTION OF THE INVENTION

A keyboard according to the present invention will be described with reference to some embodiments in conjunction with the accompanying drawings. However, those skilled in the art should easily understand that the drawings and texts are only for the illustrative purpose and do not intend to limit the scope of the invention.

### First Embodiment

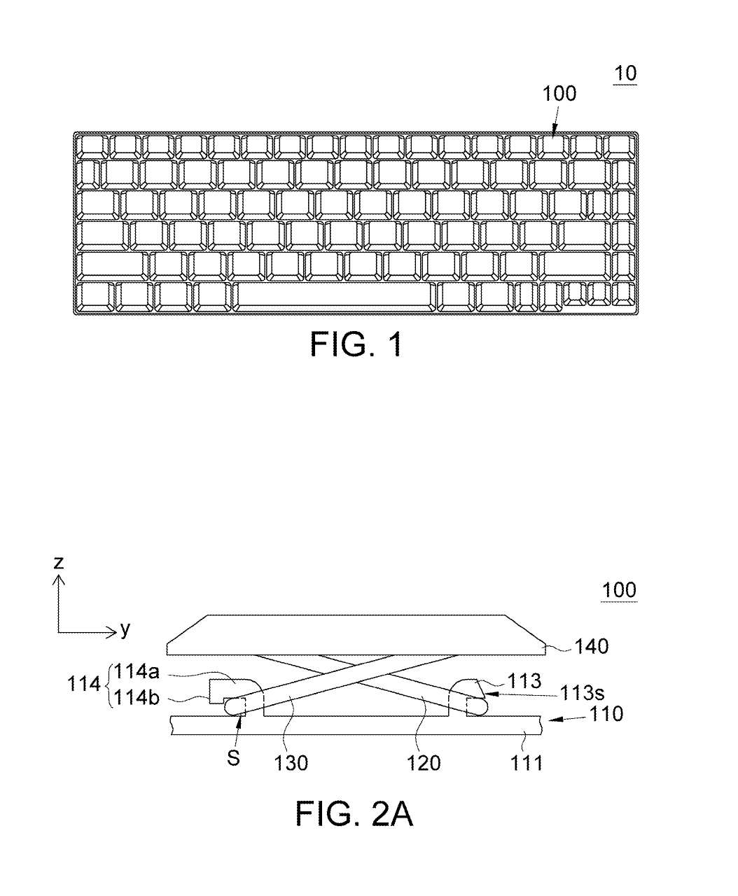

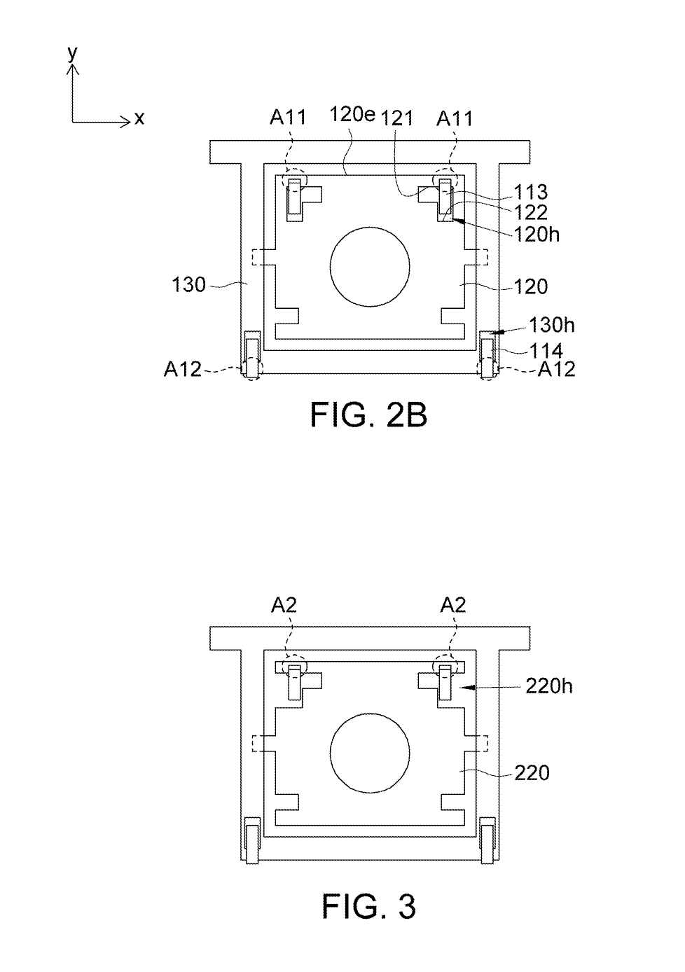

Please refer to FIGS. 1, 2A and 2B. FIG. 1 is a schematic illustration showing a keyboard 10 according to a first embodiment of the present invention. FIG. 2A is a side view showing one of the keys 100 in FIG. 1. FIG. 2B is a top view showing the key 100 in FIG. 2A without a key cap 140.

The keyboard 10 may be, for example, a desktop keyboard and includes a plurality of keys 100. Each key 100 includes a base 110, an inner frame 120, an outer frame 130 and a key cap 140. The base 110 has a body 111, two first hooks 113 and two second hooks 114. The first hooks 113 and the second hooks 114 are connected to and protrude from the body 111. In this embodiment, each first hook 113 is an L-shaped structure, which has one end connected to the body 111, and the other end having an inclined surface 113s. The height of the inclined surface 113s is gradually reduced in a direction reverse to a direction toward a position where the second hook 114 is located. Each second hook 114 has an L-shaped portion 114a and an inverse hook portion 114b. One end of the L-shaped portion 114a is connected to the body 111. The inverse hook portion 114b extends from the other end of the L-shaped portion 114a to the body 111 so as to form a space S.

The inner frame 120 is obliquely disposed on the body 111 and has two first openings 120h. In this embodiment, each first opening 120h is a closed through hole. Each first opening 120h is disposed adjacent to an edge 120e of the inner frame 120 and has a first slot wall 121 and a second slot wall 122. The first slot wall 121 is disposed opposite the second slot wall 122, and nearer to the edge 120e than the second slot wall 122. Each first hook 113 passes through the corresponding first opening 120h so as to engage with a portion of the inner frame 120 (i.e., the inner frame 120 in two regions A11). The inner frame 120 in the two regions A11 is located between the first slot wall 121 and the edge 120e.

The outer frame 130 disposed on the body 111 crosses the inner frame 120 and has two second openings 130h. Each second hook 114 passes through the corresponding second opening 130h so as to receive a portion of the outer frame 130 (i.e., the outer frame 130 in the two regions A12) in the space S of each second hook 114. The key cap 140 is disposed on the inner frame 120 and the outer frame 130.

The configuration of the key 100 of this embodiment will be described by way of the assembling processes of the outer frame 130 and the inner frame 120. The outer frame 130 in the two regions A12 is received in the space S of each second hook 114 in a movable manner in a gap between the body 111 and each inverse hook portion 114b. That is, the outer frame 130 is moved firstly in the y-axis direction. After passing through the gap between the body 111 and each inverse hook portion 114b, the outer frame 130 in the two regions A12 is received in the space S of each second hook 114. Consequently, the outer frame 130 may firmly engage with the second hook 114 through the configuration of the inverse hook portion 114b. Next, the inner frame 120 in the two regions A11 engages with the first hook 113 in a rotatable manner with respect to the outer frame 130 and in a deformable manner upon contacting with the first hook 113 when the outer frame 130 in the two regions A12 is received in the space S of each second hook 114.

Herein, the length of the first slot wall 121 of the first opening 120h is greater than the length of the second slot wall 122, so that the inner frame 120 in the two regions A11 forms a structure similar to a cantilever arm. Consequently, when the inner frame 120 contacts with the first hook 113, the inner frame 120 contacting with the first hook 113 provides the function similar to a fulcrum. Thus, the inner frame 120, which does not contact with the first hook 113, tends to deform. At this time, one end of the first hook 113 having the inclined surface 113s can assist the inner frame 120 to slide in the direction toward the body 111, so that the inner frame 120 can engage with the first hook 113 smoothly. Under the limitation of the structure configuration, the conventional method of assembling the key usually includes the three steps of pushing the sliding end, engaging into the rotating end, and pushing the rotating end to the predetermined position. In contrast, the number of assembling steps of the key 100 of this embodiment is fewer, so that the assembling efficiency is enhanced and the manufacturing cost and time can be saved.

Furthermore, in order to prevent the inner frame 120 from shaking during operation, the length of the second slot wall 122 of the first opening 120h in the x direction approximates the width of the first hook 113 in the x direction. Consequently, the shaking of the inner frame 120 during operation can be reduced through the dimensional design of the second slot wall 122 and the first hook 113.

Consequently, when the user presses the key cap 140, the outer frame 130 received in the space S (the outer frame 130 in the two regions A12) serves as a rotating end, and the inner frame 120 engaging with the first hook 113 (the inner frame 120 in the two regions A11) serves as a moving end to implement the reciprocating motion.

### Second Embodiment

FIG. 3 is a partially schematic illustration showing a key according to a second embodiment of the present invention. Compared with the key 100 of the first embodiment, each first opening 220h of the key of this embodiment is an open through hole, so that a portion of the inner frame 220 (i.e., the inner frame 220 in the two regions A2) forms two cantilever arms. Consequently, the deformation of the inner frame 220 in the two regions A2 becomes easier, so that the convenience of assembling the key of this embodiment can be significantly enhanced. In addition, the other designs of the key of this embodiment are similar to those of the key 100 of the first embodiment. Thus, the key of this embodiment can achieve the effects similar to those of the key 100 of the first embodiment.

### Third Embodiment

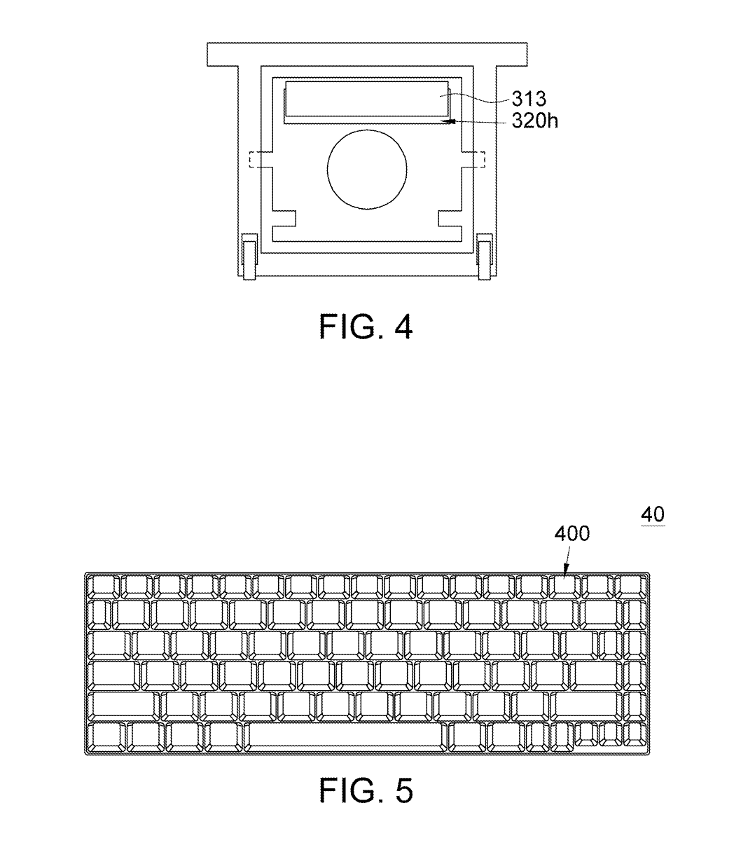

FIG. 4 is a partially schematic illustration showing a key according to a third embodiment of the present invention. Compared with the key 100 of the first embodiment, the key of this embodiment has only one first opening 320h, and only one first hook 313. The other designs of the key of this embodiment is similar to those of the key 100 of the first embodiment. Thus, the key of this embodiment can achieve the effects similar to those of the key 100 of the first embodiment.

### Fourth Embodiment

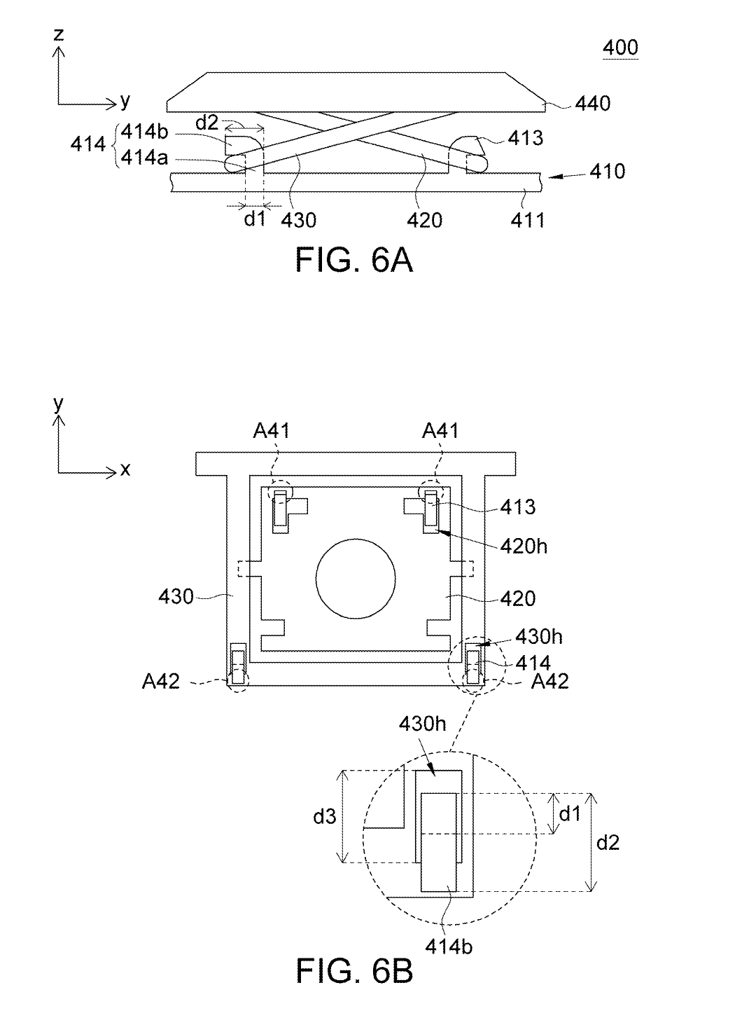

Please refer to FIGS. 5, 6A and 6B. FIG. 5 is a schematic illustration showing a keyboard 40 according to a fourth embodiment of the present invention. FIG. 6A is a side view showing one of the keys 400 in FIG. 5. FIG. 6B is a top view showing the key 400 in FIG. 6A without a key cap 440.

The keyboard 40 may be, for example, a desktop keyboard, and includes a plurality of keys 400. Each key 400 includes a base 410, an inner frame 420, an outer frame 430 and a key cap 440. The base 410 has a body 411, two first hooks 413 and two second hooks 414. The first hooks 413 and the second hooks 414 are connected to and protrude from the body 411. In this embodiment, the design of each first hook 413 is similar to that of the first hook 113 of the first embodiment, and detailed descriptions thereof will be omitted. Each second hook 414 is an L-shaped member having a first rod 414a and a second rod 414b. The first rod 414a has one end connected to the body 411, and the other end connected to one end of the second rod 414b. A length d2 of the second rod 414b in a direction (i.e., the ±y direction) is greater than a length d1 of the first rod 414a in the ±y direction.

The inner frame 420 is obliquely disposed on the body 411 and has two first openings 420h. In this embodiment, the design of each first opening 420h is similar to that of the first opening 120h of the first embodiment, and detailed descriptions thereof will be omitted. Each first hook 413 passes through the corresponding first opening 420h so as to engage with a portion of the inner frame 420 (i.e., the inner frame 420 in two regions A41).

The outer frame 430 disposed on the body 411 crosses the inner frame 420 and has two second openings 430h. A length d3 of each second opening 430h in the ±y direction ranges between the length d2 of the second rod 414b in the ±y direction and the length d1 of the first rod 414a in the ±y direction. Each second hook 414 passes through the corresponding second opening 430h so as to engage with a portion of the outer frame 430 (i.e., the outer frame 430 in the two regions A42). The key cap 440 is disposed on the inner frame 420 and the outer frame 430.

The configuration of the key 400 of this embodiment will be described by way of the assembling processes of the outer frame 430 and the inner frame 420. The outer frame 430 in the two regions A42 engages with each second hook 414 in a movable manner in the gap between the body 411 and the second rod 414b. Because the length d3 of each second opening 430h in the ±y direction ranges between the length d2 of the second rod 414b in the ±y direction and the length d1 of the first rod 414a in the ±y direction, the outer frame 430 obliquely lets the second hook 414 passes through the second opening 430h so as to engage with the second hook 414. Consequently, the outer frame 430 can firmly engage with the second hook 414 through the dimensional design, and thus cannot be easily separated from the second hook 414. Next, the inner frame 420 in the two regions A41 engages with the first hook 413 in a rotatable manner with respect to the outer frame 430 and in a deformable manner upon contacting with the first hook 413 when the outer frame 430 in the two regions A42 engages with each second hook 414. Consequently, the steps of assembling the key 400 are easy, so that the assembling convenience is greatly enhanced.

The other designs of the key 400 of this embodiment are similar to those of the key 100 of the first embodiment. Thus, the key 400 of this embodiment can achieve the effects similar to those of the key 100 of the first embodiment.

### Fifth Embodiment

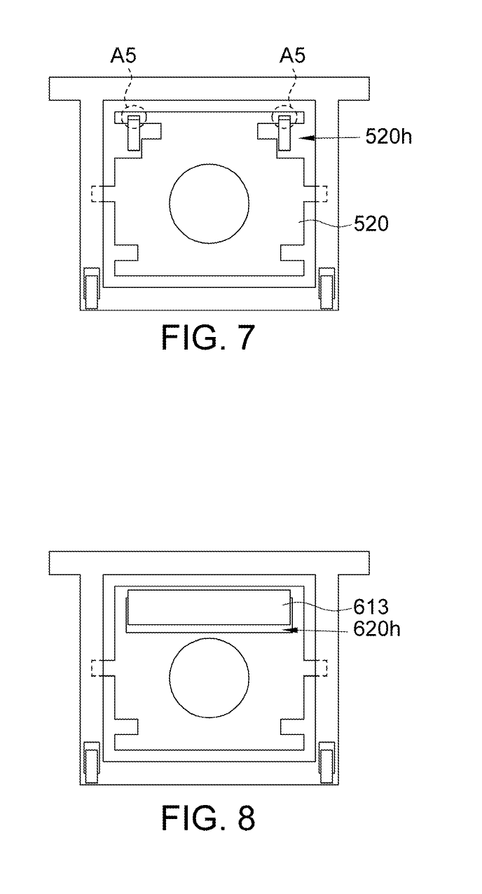

FIG. 7 is a partially schematic illustration showing a key according to a fifth embodiment of the present invention. Compared with the key 400 of the fourth embodiment, each first opening 520h of the key of this embodiment is an open through hole, so that a portion of an inner frame 520 (i.e., the inner frame 520 in two regions A5) forms two cantilever arms. Consequently, the deformation of the inner frame 520 in the two regions A5 becomes easier, such that the convenience of assembling the key of this embodiment can be greatly enhanced. In addition, the other designs of the key of this embodiment are similar to those of the key 400 of the fourth embodiment. Thus, the key of this embodiment can achieve the effects similar to those of the key 400 of the fourth embodiment.

### Sixth embodiment

FIG. 8 is a partially schematic illustration showing a key according to a sixth embodiment of the present invention. Compared with the key 400 of the fourth embodiment, the key of this embodiment has only one first opening 620h, and only one first hook 613. The other designs of the key of this embodiment are similar to those of the key 400 of the fourth embodiment. Thus, the key of this embodiment can achieve the effects similar to those of the key 400 of the fourth embodiment.

In the keyboard according to the embodiments of the invention, the structure of the key of the keyboard is configured such that the key can be easily assembled. In one embodiment, the second hook of the key has the L-shaped portion and the inverse hook portion so as to receive the outer frame in the space, formed by the L-shaped portion and the inverse hook portion, and to provide the engaging function. In another embodiment, the dimensions of the first rod and the second rod of the second hook of the key as well as the second opening are configured such that the engaging function can be provided. Consequently, the keyboard according to these embodiments can be easily assembled so that the manufacturing time can be shortened and the manufacturing cost can be decreased.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keyboard, comprising:
a plurality of keys, each of which comprises:
a base having a body, a first hook and two second hooks, wherein the first hook and the second hooks are connected to and protrude from the body, each of the second hooks has an L-shaped portion and an inverse hook portion, one end of the L-shaped portion is connected to the body, and the inverse hook portion extends from the other end of the L-shaped portion to the body so as to form a space;
an inner frame, which is obliquely disposed on the body and has a first opening, wherein the first hook passes through the first opening so as to engage with a portion of the inner frame;
an outer frame, which is disposed on the body, crosses the inner frame and has two second openings, wherein each of the second hooks passes through the corresponding second opening so as to receive a portion of the outer frame in the space of each of the second hooks; and
a key cap disposed on the inner frame and the outer frame.

2. The keyboard according to claim 1, wherein the base has two first hooks, the inner frame has two first openings, each of the first openings is disposed adjacent to an edge of the inner frame, and has a first slot wall and a second slot wall, the first slot wall is disposed opposite the second slot wall and is disposed nearer to the edge than the second slot wall, each of the first hooks passes through the corresponding first opening so as to engage with the portion of the inner frame, the portion of the inner frame is located between the first slot wall and the edge, and a length of the first slot wall is greater than a length of the second slot wall.

3. The keyboard according to claim 2, wherein each of the first openings is a closed through hole.

4. The keyboard according to claim 2, wherein each of the first openings is an open through hole, and the portion of the inner frame comprises two cantilever arms.

5. The keyboard according to claim 1, wherein the first hook is an L-shaped structure having one end connected to the body, and the other end having an inclined surface, wherein a height of the inclined surface is gradually reduced in a direction reverse to a direction toward a position where the second hook is located.

6. The keyboard according to claim 1, wherein the portion of the outer frame is received in the space of each of the second hooks in a movable manner in a gap between the body and each of the inverse hook portions.

7. The keyboard according to claim 6, wherein the portion of the inner frame engages with the first hook in a rotatable manner with respect to the outer frame and in a deformable manner upon contacting with the first hook when the portion of the outer frame is received in the space of each of the second hooks.

8. A keyboard, comprising:
a plurality of keys, each of which comprises:
a base having a body, a first hook and two second hooks, wherein the first hook and the second hooks are connected to and protrude from the body, each of the second hooks is an L-shaped member having a first rod and a second rod, one end of the first rod is connected to the body, the other end of the first rod is connected to one end of the second rod, a length of the second rod in a direction is greater than a length of the first rod in the direction;
an inner frame, which is obliquely disposed on the body and has a first opening, wherein the first hook passes through the first opening so as to engage with a portion of the inner frame;
an outer frame, which is disposed on the body, crosses the inner frame and has two second openings, wherein a length of each of the second openings in the direction ranges between the length of the second rod in the direction and the length of the first rod in the direction, and each of the second hooks passes through the corresponding second opening so as to engage with a portion of the outer frame; and
a key cap disposed on the inner frame and the outer frame.

9. The keyboard according to claim 8, wherein the base has two first hooks, the inner frame has two first openings, each of the first openings is disposed adjacent to an edge of the inner frame, and has a first slot wall and a second slot wall, the first slot wall is disposed opposite the second slot wall and is disposed nearer to the edge than the second slot wall, each of the first hooks passes through the corresponding first opening so as to engage with the portion of the inner frame, the portion of the inner frame is located between the first slot wall and the edge, and a length of the first slot wall is greater than a length of the second slot wall.

10. The keyboard according to claim 9, wherein each of the first openings is a closed through hole.

11. The keyboard according to claim 9, wherein each of the first openings is an open through hole, and the portion of the inner frame comprises two cantilever arms.

12. The keyboard according to claim 8, wherein the first hook is an L-shaped structure having one end connected to the body, and the other end having an inclined surface, wherein a height of the inclined surface is gradually reduced in a direction reverse to a direction toward a position where the second hook is located.

13. The keyboard according to claim 8, wherein the portion of the outer frame engages with each of the second hooks in a movable manner in a gap between the body and each of the second rods.

14. The keyboard according to claim 13, wherein the portion of the inner frame engages with the first hook in a rotatable manner with respect to the outer frame and in a deformable manner upon contacting with the first hook when the portion of the outer frame engages with each of the second hooks.
